(19) United States
(12) Patent Application Publication
(10) Pub. No.: US 2017/0310223 A1
(43) Pub. Date: Oct. 26, 2017

(54) POWER ADAPTER AND METHOD FOR FIXING DC VOLTAGE GAIN THEREOF

(71) Applicant: Chicony Power Technology Co., Ltd., New Taipei City (TW)

(72) Inventors: Yang WANG, New Taipei City (TW); Pei-Hsun YANG, New Taipei City (TW)

(21) Appl. No.: 15/244,437

(22) Filed: Aug. 23, 2016

(30) Foreign Application Priority Data
Apr. 21, 2016 (TW) 105205605

(51) Int. Cl. H02M 3/335; H02M 1/42; H02M 1/14

(52) U.S. Cl. CPC H02M 3/33507; H02M 1/14; H02M 1/42

(57) ABSTRACT

A power adapter and a method for fixing DC voltage gain thereof are disclosed. The power adapter applied for powering an electronic device includes a voltage converter, an LLC converter, and a controlling module. The LLC converter is electrically connected to the voltage converter and receives an input voltage provided by the voltage converter. The controlling module with a plurality of controlling modes is electrically connected to the voltage converter, the LLC converter, and the electronic device; the controlling module selects one of the controlling modes in accordance with a voltage requirement of the electronic device, the controlling module further drives the voltage converter to provide the input voltage based on the selected controlling mode, which makes the LLC converter to provide an output voltage to fit the voltage requirement of the electronic device, thus a DC voltage gain of the power adapter is fixed.

### BACKGROUND

### Technical Field

The present disclosure relates to a power adapter. More particularly, the present disclosure relates to a power adapter, which selectively provides different output voltages to fit different voltage requirements, and method for fixing DC voltage gain of the power adapter.

### Description of Related Art

Inductor-inductor-capacitor (LLC) power converters are an increasingly important part of power conversion systems. LLC power converters have a number of advantages when compared to other power converters, such as high efficiency. In general, the output voltage of the LLC converter is varied when its input voltage varies; however, this results in high switching loss when the input voltage Vin is small, i.e., under light load.

In order to overcome the problem of high switching loss under light load operation, the LLC converter can be designed to output a determined voltage by fixing its input voltage; however, this gives the LLC converter cannot be compatible for use in different electronic devices.

### SUMMARY

According to one aspect of the present disclosure, a power adapter applied for powering an electronic device includes a voltage converter, an LLC converter, and a controlling module. The LLC converter is electrically connected to the voltage converter and receives an input voltage provided by the voltage converter. The controlling module with a plurality of controlling modes is electrically connected to the voltage converter, the LLC converter, and the electronic device; the controlling module selects one of the controlling modes in accordance with a voltage requirement of the electronic device, the controlling module further drives the voltage converter to provide the input voltage based on the selected controlling mode, which makes the LLC converter to provide an output voltage to fit the voltage requirement of the electronic device, thus a DC voltage gain of the power adapter is fixed.

In an embodiment of the present disclosure, the controlling module can include a handshaking unit and a controlling unit, the handshaking unit is configured to sense the voltage requirement of the electronic device; and the controlling unit is electrically connected to the handshaking unit, the voltage converter, and the LLC converter. The controlling unit make the LLC converter provide the output voltage to fit the voltage requirement of the electronic device based on a sensed signal generated by the handshaking unit, the controlling unit further regulates the input voltage based on the output voltage fit the voltage requirement of the electronic device to make the DC voltage gain of the power adapter be a constant.

In an embodiment of the present disclosure, the relationship between the outputted voltage and the input voltage is a fixed ratio, and the fixed ratio can be in a range of 16˜20.

In another embodiment of the present disclosure, the fixed DC voltage gain equals to a turns ratio divides by a half of the fixed ratio.

In still another embodiment of the present disclosure, the voltage converter can be a boost converter, a buck converter, a buck-boost converter or a power factor corrector.

According to another aspect of the present disclosure, a method for fixing gain of a power adapter includes following steps: first, a power adapter applied to provide a plurality of output voltages and including an LLC converter is provided; thereafter, a voltage requirement of an electronic device electrically connected to the power adapter is sensed; after that one of the output voltage is selected to fit the voltage requirement of the electronic device, and then an input voltage of the LLC converter is regulated based on the selected output voltage to make the power adapter have a fixed DC voltage gain.

In an embodiment of the present disclosure, the relationship between the outputted voltage and the input voltage is a fixed ratio, and the fixed ratio can be in a range of 16˜20.

### BRIEF DESCRIPTION OF DRAWING

The present disclosure can be more fully understood by reading the following detailed description of the embodiment, with reference made to the accompanying drawings as follows:

FIG. 1 is a circuit block diagram of a power adapter according to the present disclosure;

FIG. 2 is a circuit diagram of an LLC converter according to the present disclosure;

FIG. 3 is a diagram showing DC voltage gain curves according to the operation frequency when the input voltage of the LLC converter is varied;

FIG. 4 is a diagram showing DC voltage gain curves according to the operation frequency when the input voltage of the LLC converter is fixed; and

FIG. 5 is a diagram showing DC voltage gain curves according to the operation frequency when the input voltage of the LLC converter is designed.

### DETAILED DESCRIPTION

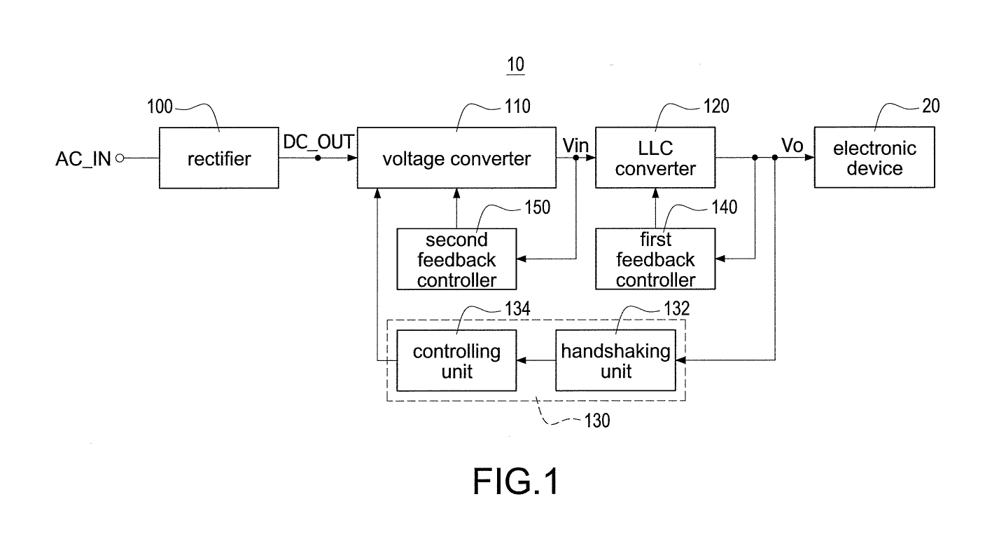

Reference is made to FIG. 1, which is a circuit block diagram of a power adapter according to the present disclosure. In FIG. 1, the power adapter 10 is electrically connected to an electronic device 20 and configured to provide different (direct current) output voltages to fit different voltage requirements of electronic devices 20. More particularly, the output voltage is in the range of 5V˜20V, and can be 5V, 12V, and 20V.

The power adapter 10 includes a rectifier 100, a voltage converter 110, an LLC (resonant) converter 120, and a controlling module 130. The rectifier 100 is electrically connected to a commercial power source for receiving an alternative current (AC) input voltage AC_IN supplied therefrom. The LLC converter 120 is electrically connected to the electronic device 20, and the voltage converter 110 is arranged between the rectifier 100 and the LLC converter 120 and electrically connected thereto.

The rectifier 100 is configured to rectify the AC input voltage AC_IN into a full-wave rectified direct current (DC) voltage DC_OUT. The rectifier 100 is, for example, a bridge rectifier constituted by four diodes.

The voltage converter 110 is electrically connected to the rectifier 100 and is configured to regulate the full-wave rectified DC voltage DC_OUT and/or correct power factor of the full-wave rectified DC voltage DC_OUT. The voltage converter 110 can be boost converter, buck converter, buck-boost converter, or power factor corrector; the boost converter, the buck converter, and the buck-boost converter are configured to regulate the full-wave rectified DC voltage; the power factor corrector is configured to correct the power factor of the full-wave rectified DC voltage DC_OUT by drawing current in phase of voltage and boost the full-wave rectified DC voltage DC_OUT to an input voltage Vin for delivery to the LLC converter 120.

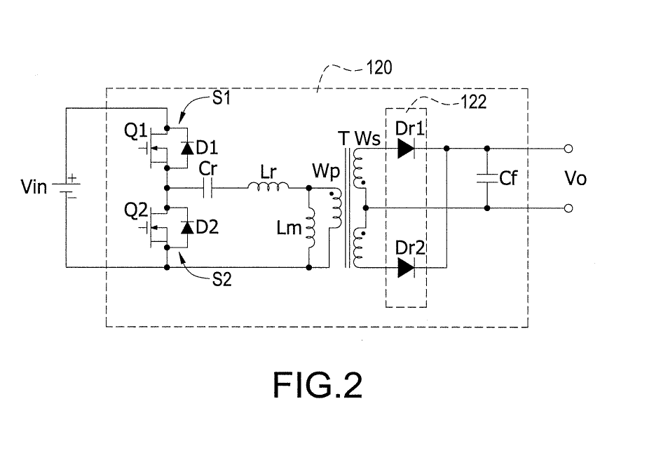

The LLC converter 120 is electrically connected to the voltage converter 110 and receives the input voltage Vin provided by the voltage converter 110. Reference is made to FIG. 2, which is a circuit diagram of the LLC converter according to the present disclosure. In FIG. 2, the LLC converter 120 includes switch assemblies S1 and S2, a resonant capacitor Cr, a resonant inductor Lr, a magnetizing inductor Lm, a transformer T, a rectifying unit 122, and an output filter Cf.

The switch assembly S1 includes a power switch Q1 and a diode D1 electrically connected in parallel, and the switch assembly S2 includes a power switch Q2 and a diode D2 electrically connected in parallel. The power switches Q1 and Q2 are, for example, metal-oxide-semiconductor field-effect transistors (MOSFETs). The source of the power switch Q1 is electrically connected to the drain of the power switch Q2, and the drain of the power switch Q1 and the source of the power switch Q2 are electrically connected to the voltage converter 110 shown in FIG. 1 for receiving the input voltage Vin provided by the voltage converter 110. The anode of the diode D1 is connected to the source of the power switch Q1, and the cathode thereof is connected to the drain of the power switch Q1; the diode D1 can be the body diode of the power switch Q1. The anode of the diode D2 is connected to the source of the power switch Q2, and the cathode thereof is connected to the drain of the power switch Q2; the diode D2 can be the body diode of the power switch Q2.

The power switch Q1 and the power switch Q2 receives the input voltage Vin provided by the voltage converter 110; the gates of the power switches Q1 and Q2 receive signals provided by the first feedback controller 140 and then a square wave corresponding to on/off states of the power switches Q1 and Q2 is generated.

The transformer T has a primary winding Wp and a center tapped secondary winding Ws coupled to the primary winding Wp. The resonant capacitor Cr is connected to the source of the power switch Q1 and the drain of the power switch Q2 such that the resonant capacitor Cr receives the square wave corresponding to on/off states of the power switches Q1 and Q2. The magnetizing inductor Lm is electrically connected to the primary winding Wp of the transformer T in parallel. The resonant inductor Lr is arranged between the resonant capacitor Cr and the magnetizing inductor Lm and electrically connected thereto. The resonant capacitor Cr is not only used for blocking DC component of the square wave but also constructing a resonant tank with the resonant inductor Lr and magnetizing inductor Lm.

The rectifying unit 102 includes two rectifying diodes Dr1 and Dr2. The rectifying diodes Dr1 and Dr2 are electrically connected to the secondary windings Ws such that a full-bridge rectifying circuit is constituted to convert an AC voltage outputted from the secondary winding Ws into a DC output voltage with high-frequency ripple component.

The output filter Cf is connected to the rectifying unit 122 and configured to filter high-frequency ripple component of the DC output voltage outputted from the rectifying unit 122 and outputs a stable DC output voltage Vo. The DC output voltage Vo is conducted to the electronic device 20 for powering the electronic device 20.

The LLC converter is based on the fundamental concept that

M=(n×Vo)/(Vin÷2);

where:

M is the DC voltage gain of the LLC converter 120;

n is the turns ratio between the primary winding Wp and the secondary winding Ws of the transformer T;

Vo is the DC output voltage of the LLC converter 120; and

Vin is the input voltage provided from the voltage converter 110 to the LLC converter 120.

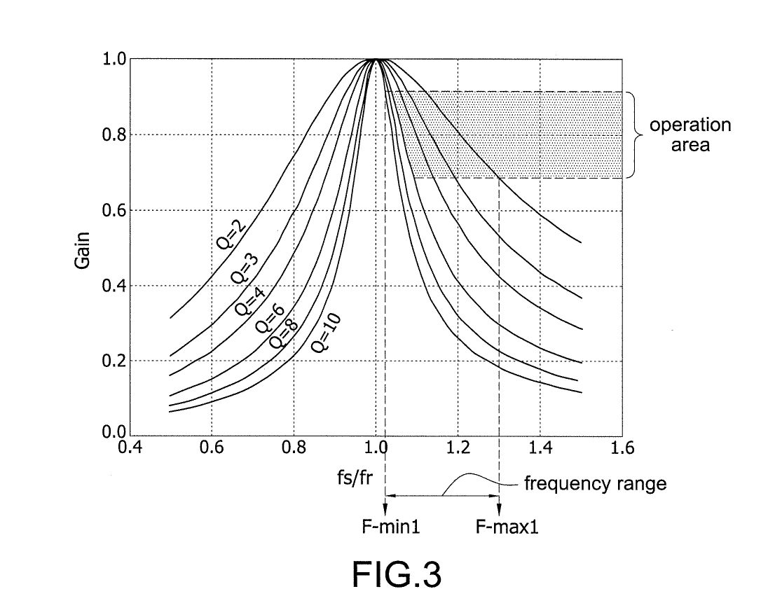

Under this fundamental concept, the LLC converter 120 might require very wide frequency range to provide sufficient DC voltage gain when the input voltage Vin varies. This may result in a high switching loss when the input voltage Vin is small, i.e., under light load operation (as curve Q=2 shown in FIG. 3) and poor operation efficiency. FIG. 3 is a diagram showing DC voltage gain curves according to the operation frequency (such as the switching frequency of the switching assemblies S1 and S2) when the input voltage Vi of the LLC converter 120 is varied, and frequency range to provide sufficient DC voltage gain is between a minimum frequency F-min1 and a maximum frequency F-max1.

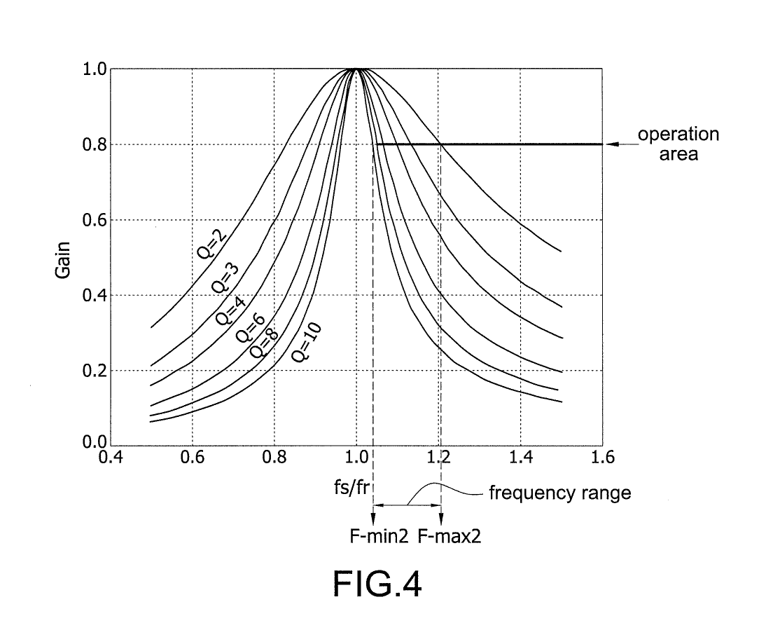

The voltage converter 110 is typically designed to operate the LLC converter 120 in a fixed input voltage Vin, i.e., the input voltage Vi is a constant. This results in a narrow frequency range of LLC converter 120. Reference is made to FIG. 4, which is a diagram showing DC voltage gain curves according to the frequency when the input voltage Vi of the LLC converter 120 is fixed. In FIG. 4, the frequency range to operate the LLC converter 120 is between a minimum frequency F-min2 and a maximum frequency F-max2, which is narrower than the frequency range between the minimum frequency F-min1 and the maximum frequency F-max1 shown in FIG. 3. Thus the problems of high switching loss under light load operation and poor operation efficiency mentioned above are solved. In accordance with the fundamental concept mentioned above, since the input voltage Vi of the LLC converter 120 is a constant, the DC output voltage Vo must be fixed; this gives the DC output voltage Vo cannot be compatible for use in different electronic devices 20.

Therefore, the controlling module 130 of the present disclosure is used for the addition function of sensing the DC output voltage Vo of the power adapter 10 and regulating the input voltage Vi of the LLC converter 120 based on the DC output voltage Vo. As a result, a fixed DC voltage gain is provided.

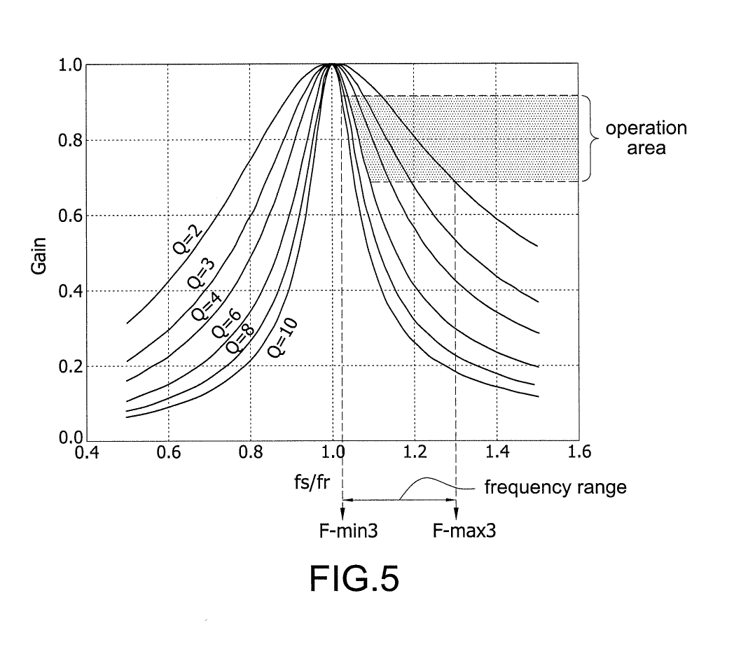

More particularly, the controlling module 130 includes a handshaking unit 132 and a controlling unit 134; the handshaking unit 132 is electrically connected to the LLC converter 120 and the electronic device 20, and the controlling unit 134 is electrically connected to the handshaking unit 132 and the voltage converter 110. The controlling module 130 has a plurality of controlling modes corresponding to different levels of the DC output voltage Vo. The controlling module 130 senses the voltage requirement of the electronic device 20 (i.e., the DC output voltage Vo required for the electronic device 20) and selects one of the controlling modes of the power adapter 10 based on the voltage requirement of the electronic device 20 (may be the instantaneous value of the DC output voltage Vo). Thereafter, the controller module 130 generates signals for driving the voltage converter 110 in accordance with the selected controlling mode, so that the input voltage Vi is regulated. As such, the DC output voltage Vo fit the voltage requirement of the electronic device 20 will delivery to the electronic device 20. The LLC converter 120 is operated within the frequency range between a minimum frequency F-min3 and a maximum frequency F-max3 shown in FIG. 5.

Consequently, the power adapter 10 of the present disclosure is capable of providing different DC output voltages Vo with a fixed gain. This gives the power adapter 10 can be compatible for use in different electronic devices 20. In addition, the frequency range between the minimum frequency F-min3 and the maximum frequency F-max3 shown in FIG. 5 is narrower than the frequency range between the minimum frequency F-min1 and the maximum frequency F-max1 shown in FIG. 3, thus high operation efficiency is achieved and the problem of high switching loss may be overcome.

With referring again with FIG. 1, the handshaking unit 132 is configured to communicate with the electronic device 20. More particularly, when the power adapter 10 is electrically connected to the electronic device 20, the handshaking unit 132 provides information of the DC output voltages Vo, which are provided by the power adapter 10, to the electronic device 20. This enables the electronic device 20 to select the proper DC output voltage from the DC output voltages provided by the power adapter 10.

As a result, a signal is generated, which is followed by the proper DC output voltage that selected by the electronic device 20. Thereafter, one of the controlling modes should be selected based upon the DC output voltage fit the requirement of the electronic device 20 by the controlling unit 134. The voltage converter 110 is driven, and the input voltage is regulated in accordance with the selected DC output voltage Vo. When the input voltage Vin provided by the voltage converter 110 to the LLC converter 120 is Vin, the DC output voltage of the LLC converter 120 is Vo, and a defined ratio between the DC output voltage Vo and the input voltage Vi is K, the following condition is satisfied:

Vin=K×Vo.

In short, the controlling unit 134 makes the voltage converter 110 provide the input voltage Vi in accordance with the DC output voltage Vo of the selected controlling mode. This gives the DC voltage gain of the power adapter 10 to be a constant. In addition, the power adapter 10 can provide different DC output voltages Vo to fit different voltage requirements of electronic device(s) 20, and the frequency range for operating the LLC converter 120 of the present disclosure is expanded (as shown in FIG. 5).

It should be noted that when a minimum of the AC input voltage AC_IN is 80V, the maximum of the DC output voltage Vo of the power adapter 10 is 20V, the minimum of the DC output voltage Vo is 5V, and the defined ration is K, the following condition is satisfied:

16≦K≦20.

Besides, when the DC voltage gain of the power adapter 10 is M, the turns ratio between the primary winding Wp and the secondary winding Ws of the transformer T is n, and the defined ratio is K, the following condition is satisfied:

M=n/(K÷2).

The power adapter 10 further includes the first feedback controller 140 and the second feedback controller 150; the first feedback controller 140 is electrically connected to the LLC converter 120 and configured to control operations of the LLC converter in accordance with the DC output voltage Vo; the second feedback controller 150 is electrically connected to the voltage converter 110 and configured to control operations of the voltage converter 110 in accordance with the input voltage Vin provided by the voltage converter 110 to the LLC converter 120.

With referring again to FIG. 1, the power adapter 10 of the present disclosure may provide the DC output voltages to fit different voltage requirements with the fixed DC gain by following steps: first, a power adapter 10 with a plurality of controlling modes and including an LLC converter 120 is provided, wherein each of the controlling mode is in accordance with one of the DC output voltages. Thereafter, the power adapter 10 selects one of the DC output voltages Vo to fit the voltage requirement of the electronic device 20; wherein the DC output voltage selection may be, for example, executed by the electronic device 20, which selects one of the DC output voltages Vo provided by the power adapter 10. After that, the power adapter 10 outputs the DC output voltage Vo required for the electronic device 20 to the electronic device 20. More particularly, the input voltage Vi of the LLC converter 120 is controlled in accordance with the selected DC output voltage Vo to make the power adapter 10 have a fixed DC voltage gain. The fixed DC gain between the DC output voltage Vo and the input voltage Vi is between 16˜20.

Although the present disclosure has been described with reference to the foregoing preferred embodiment, it will be understood that the disclosure is not limited to the details thereof. Various equivalent variations and modifications can still occur to those skilled in this art in view of the teachings of the present disclosure. Thus, all such variations and equivalent modifications are also embraced within the scope of the disclosure as defined in the appended claims.

What is claimed is:

1. A power adapter applied for powering an electronic device comprising:
a voltage converter;
an LLC converter electrically connected to the voltage converter and receiving an input voltage provided by the voltage converter; and
a controlling module with a plurality of controlling modes electrically connected to the voltage converter, the LLC converter, and the electronic device,
wherein the controlling module selects one of the controlling modes in accordance with a voltage requirement of the electronic device, the controlling module further drives the voltage converter to provide the input voltage based on the selected controlling mode, which makes the LLC converter to provide an output voltage to fit the voltage requirement of the electronic device, thus a DC voltage gain of the power adapter is fixed.

2. The power adapter of claim 1, wherein the controlling module comprises:
a handshaking unit configured to sense the voltage requirement of the electronic device; and
a controlling unit electrically connected to the handshaking unit, the voltage converter, and the LLC converter, wherein the controlling unit make the LLC converter provide the output voltage to fit the voltage requirement of the electronic device based on a sensed signal generated by the handshaking unit, the controlling unit further regulates the input voltage based on the output voltage fit the voltage requirement of the electronic device to make the DC voltage gain of the power adapter be a constant.

3. The power adapter of claim 1, wherein the relationship between the outputted voltage and the input voltage is a fixed ratio.

4. The power adapter of claim 3, wherein the fixed ratio is in a range of 16˜20.

5. The power adapter of claim 3, wherein the fixed DC voltage gain equals to a turns ratio divides by a half of the fixed ratio.

6. The power adapter of claim 1, wherein the voltage converter is a boost converter, a buck converter, a buck-boost converter or a power factor corrector.

7. A method for fixing gain of a power adapter comprising:
providing a power adapter, wherein the power adapter applied to provide a plurality of output voltages comprises an LLC converter;
sensing a voltage requirement of an electronic device electrically connected to the power adapter;
selecting one of the output voltage to fit the voltage requirement of the electronic device; and
regulating an input voltage of the LLC converter based on the selected output voltage to make the power adapter have a fixed DC voltage gain.

8. The method of claim 7, wherein the relationship between the outputted voltage and the input voltage is a fixed ratio.

9. The method of claim 8, wherein the fixed ratio is in a range of 16˜20.
